(19) United States
(12) Patent Application Publication
(10) Pub. No.: US 2023/0234459 A1
(43) Pub. Date: Jul. 27, 2023

(54) Male plug and female receptacle of charger extension cable for electric vehicles

(71) Applicant: LEADING STAND LTD., Hsinchu City (TW)

(72) Inventor: A-Ching SHEN, Hsinchu City (TW)

(21) Appl. No.: 17/585,155

(22) Filed: Jan. 26, 2022

(51) Int. Cl. B60L 53/16; H01R 31/06; H02J 7/00

(52) U.S. Cl. CPC B60L 53/16; H01R 31/065; H02J 7/0045; H01R 2201/26

(57) ABSTRACT

A male plug and a female receptacle of a charger extension cable for electric vehicles is configured to be connected between a home electric circuit and a charging gun of a respective one electric vehicle, and the male plug and the female receptacle of the charger extension cable contains: a body of the charger extension cable. The body of the charger extension cable includes a first extension cord connected with a first male plug, and the first male plug is electrically connected with the home electric circuit having an incoming terminal electrically connected with a current output end of a main power switch of the home electric circuit in a power outgoing direction. The incoming terminal has a first female receptacle connected, and the first female receptacle is electrically connected with the first male plug of the first extension cord.

### FIELD OF THE INVENTION

The present invention relates to a male plug and a female receptacle of a charger extension cable for electric vehicles which are connected with the home electric circuit electrically to enhance a charging convenience

### BACKGROUND OF THE INVENTION

New energy vehicles have become a key development project in countries all over the world in recent years, and rechargeable electric vehicles are the most common new energy vehicles currently. Rechargeable electric vehicles need to be charged at charging stations and/or other supporting charging facilities, but charging vehicles are under pressure because of the long charging time and the inability of the owners to wait for a long time. When the vehicle owner goes to the charging station to charge during the day, it is quite inconvenient because there are many private trips and pending work during the day, or because the charging place cannot be found and the charging column is insufficient. When charging at the charging station at night, the user may return to the residence or a nearby hotel to rest during the charging period. If the rest time is exceeded, the electric vehicle will be fully charged and still occupy the charging space. Therefore, the owner must pay an additional fee which occupies a parking space.

To overcome above-mentioned problem, a charger extension cable for electric vehicles has been developed in TW Patent No. M543493 by the inventor of the present invention. When the vehicle owner uses the charger extension cord to charge, they can charge anytime and anywhere during work or rest, thus reducing the anxiety and pressure because of the lacks of a charging place and charging posts. The charger extension cable for the electric vehicles of TW Patent No. M543493 is also filed and granted in CN Patent No. 201621044799.5, U.S. Pat. No. 9,744,867, DE Patent No. 202017104185.9, JP Patent No. 321260, and SE Patent No. U-201730880.

The charger extension cable for electric vehicles contains an extension cord plug connected to a household circuit, the extension cord plug connected to an electromagnetic protection switch via a first extension cord, the current output end of the electromagnetic protection switch is connected to an electricity meter, and the current output end of the electricity meter passes through a first extension cord. The second extension cord is connected to an extension cord socket, and the extension cord socket is configured to connect with the charging gun. Accordingly, it has electromagnetic protection which can improve the safety during charging and can also be connected with household circuits, so the vehicle owners can charge anywhere except charging stations or charging piles, effectively solving the problem of uneven supply of charging parking spaces.

Preferably, when using the electricity meter, it is convenient for the user to directly visually count the amount of electricity used for each charge. However, cross sections of the respective one male plug and cross sections of the respective one female receptacle are flat or polygonal, so the respective one male plug electrically contacts with the respective one female receptacle incompletely, thus reducing charging efficiency.

Furthermore, the circular-live wire pin and the circular neutral pin of the respective one male plug are arranged symmetrical to the circular ground-wire socket, the circular live-wire socket and the circular neutral-wire socket of the respective one female receptacle, thus eliminating foolproof protection and using safety of the respective one male plug and the respective one female receptacle, and increasing the charging danger.

The present invention has arisen to mitigate and/or obviate the afore-described disadvantages.

### SUMMARY OF THE INVENTION

The primary objective of the present invention is to provide a male plug and a female receptacle of a charger extension cable for electric vehicles by which cross sections of the columnar ground pin, the circular-live wire pin, and the circular neutral pin of the respective one male plug and cross sections of the circular ground-wire socket, the circular live-wire socket and the circular neutral-wire socket of the respective one female receptacle are circular so that the respective one male plug electrically contacts with the respective one female receptacle completely, thus enhancing charging efficiency.

Another objective of the present invention is to provide a male plug and a female receptacle of a charger extension cable for electric vehicles by which the columnar ground pin, the circular-live wire pin and the circular neutral pin of the respective one male plug are arranged asymmetrical to the circular ground-wire socket, the circular live-wire socket and the circular neutral-wire socket of the respective one female receptacle to obtain foolproof protection and using safety of the respective one male plug and the respective one female receptacle, reduce battery consumption, eliminate high-voltage electrical equipment, decrease the danger of high-voltage electricity and waste of resources for the country and individuals

To obtain the above mentioned objectives, a male plug and a female receptacle of a charger extension cable for electric vehicles provided by the present invention is configured to be connected between a home electric circuit and a charging gun of a respective one electric vehicle, and the male plug and the female receptacle of the charger extension cable contains: a body of the charger extension cable.

The body includes a first extension cord, a distal end of which is connected with a first male plug, and the first male plug being electrically connected with the home electric circuit. The home electric circuit has an incoming terminal electrically connected thereon and with a current output end of a main power switch of the home electric circuit in a power outgoing direction, the incoming terminal has a first female receptacle connected on an end thereof opposite to the main power switch of the home electric circuit, and the first female receptacle is electrically connected with a first end of the first male plug of the first extension cord.

The first extension cord includes an electromagnetic protection switch connected on a second end of the first extension cord. The electromagnetic protection switch has an electricity meter connected on a current output end thereof, the current output end of the electromagnetic protection switch is connected with a second female receptacle via a second extension cord, and a specification of the second female receptacle is identical to a specification of the first female receptacle. The second female receptacle is configured to connect with the charging gun of the respective electric vehicle, the charging gun includes a second male plug connected on a first end thereof, and a specification of the second male plug is identical to a specification of the first male plug. The second male plug is connected with the second female receptacle of the second extension cord, the charging gun further includes a third female receptacle connected on a second end thereof, and a specification of the third female receptacle is identical to the specifications of the first and second female receptacles.

A respective one of the first, second, third female receptacles includes a substrate, a circular ground-wire socket formed on a front end of the substrate of the respective one female receptacle, a circular live-wire socket and a circular neutral wire which are formed adjacent to the circular ground-wire socket, and a first width and a first height are formed between the circular ground-wire socket and the circular live-wire socket. A second width and a second height are formed between the circular ground-wire socket and the circular neutral-wire socket, the first width is not equal to the second width, and the first height is not equal to the second height.

A respective one of the first, second, third male plugs includes a base, a columnar ground pin formed on a front end of the base, a circular live-wire pin and a circular neutral pin which are both formed adjacent to the columnar ground pin, and the columnar ground pin corresponds to the circular ground-wire socket of the respective one female receptacle, the circular live-wire pin corresponds to the circular live-wire socket of the respective one female receptacle, and the circular neutral pin corresponds to the circular neutral-wire socket of the respective one female receptacle.

### BRIEF DESCRIPTION OF THE DRAWINGS

FIG. 1 is a cross sectional view showing the assembly of a male plug and a female receptacle of a charger extension cable for electric vehicles according to a first embodiment of the present invention.

FIG. 2 is a perspective view showing the exploded components of the male plug and the female receptacle of the charger extension cable for the electric vehicles according to the first embodiment of the present invention.

FIG. 3 is a front elevational view showing the assembly of the female receptacle of the charger extension cable for the electric vehicles according to the first embodiment of the present invention.

FIG. 4 is a cross sectional view showing the assembly of the female receptacle of the charger extension cable for the electric vehicles according to the first embodiment of the present invention.

FIG. 5 is a front elevational view showing the assembly of the male plug of the charger extension cable for the electric vehicles according to the first embodiment of the present invention.

FIG. 6 is a cross sectional view showing the assembly of the male plug of the charger extension cable for the electric vehicles according to the first embodiment of the present invention.

FIG. 7 is a cross sectional view showing the exploded components of the male plug and the female receptacle of the charger extension cable for the electric vehicles according to the first embodiment of the present invention.

FIG. 8 is a cross sectional view showing the assembly of the male plug and the female receptacle of the charger extension cable for the electric vehicles according to the first embodiment of the present invention.

FIG. 9 is another cross sectional view showing the assembly of the male plug and the female receptacle of the charger extension cable for the electric vehicles according to the first embodiment of the present invention.

FIG. 10 is a cross sectional view showing the exploded components of a male plug and a female receptacle of a charger extension cable for electric vehicles according to a second embodiment of the present invention.

FIG. 11 is a cross sectional view showing the assembly of the male plug and the female receptacle of the charger extension cable for the electric vehicles according to the second embodiment of the present invention.

FIG. 12 is a block diagram showing the structure of the male plug and the female receptacle of the charger extension cable according to the present invention.

### DETAILED DESCRIPTION OF THE PREFERRED EMBODIMENTS

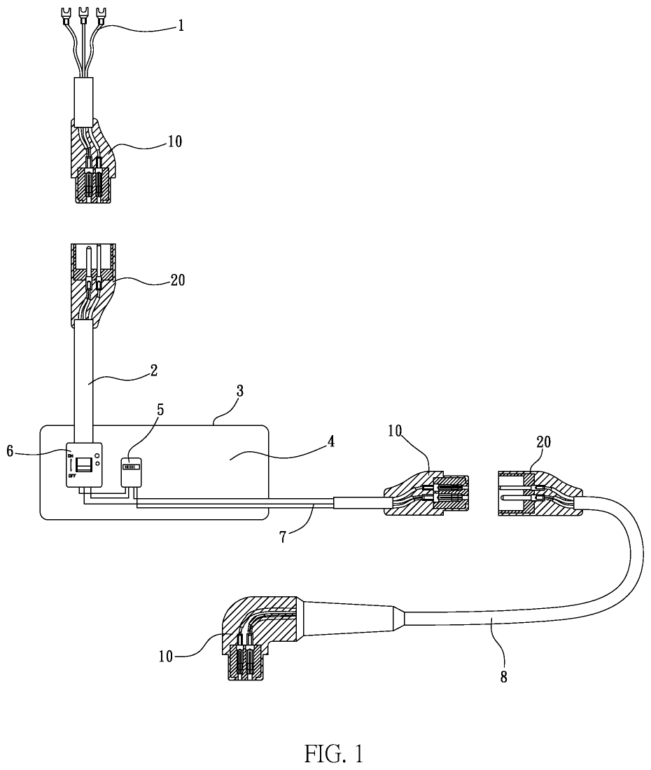

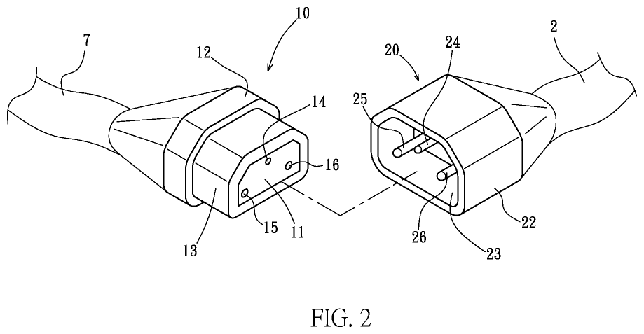

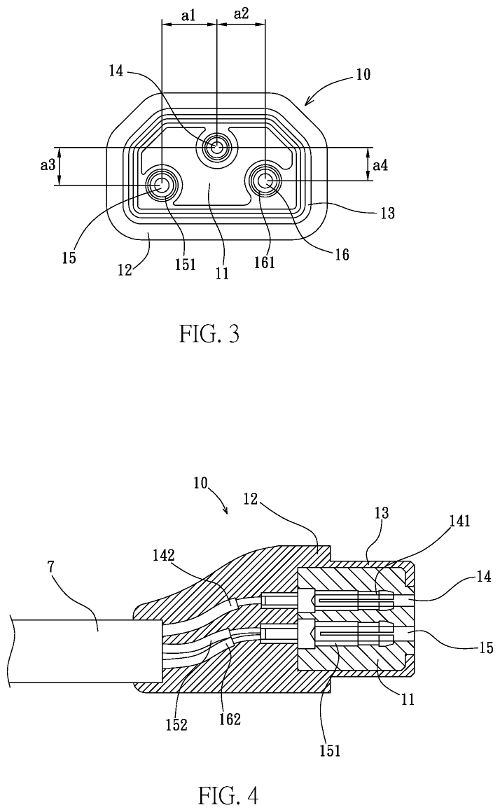

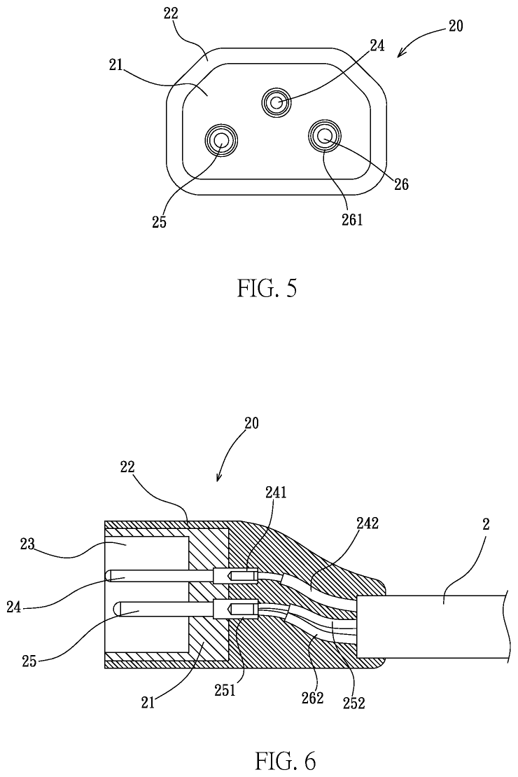

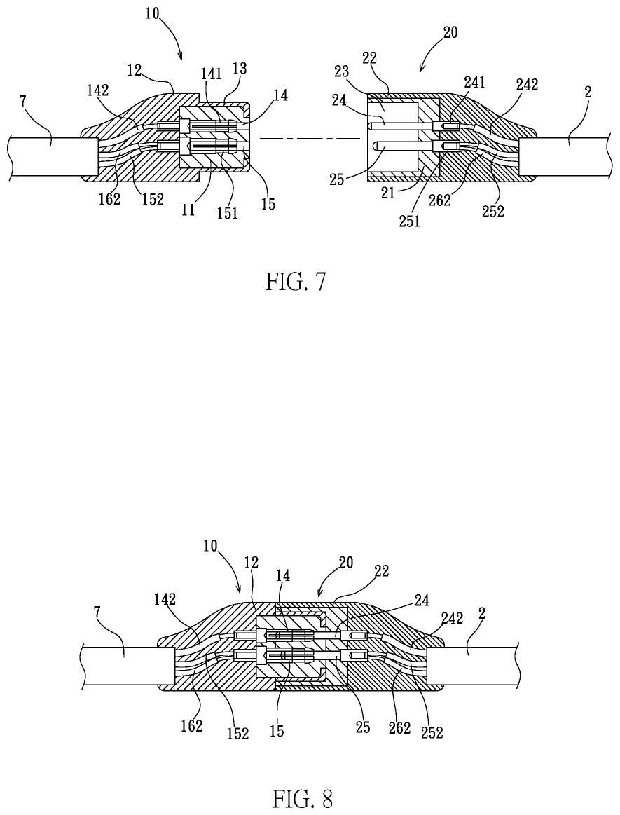

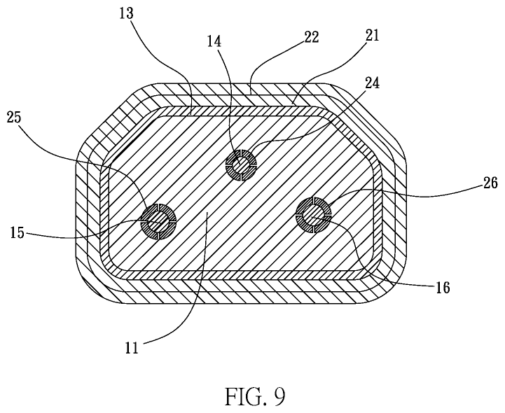

With reference to FIGS. 1-9, a male plug and a female receptacle of a charger extension cable for electric vehicles according to a first embodiment of the present invention is configured to be connected between a home electric circuit and a charging gun 8 of a respective one electric vehicle, and the male plug and the female receptacle of the charger extension cable comprise:

a body of the charger extension cable including a first extension cord 2, a distal end of which is connected with a first male plug 20, and the first male plug 20 being electrically connected with the home electric circuit, wherein the home electric circuit has an incoming terminal 1 electrically connected thereon and with a current output end of a main power switch of the home electric circuit in a power outgoing direction, the incoming terminal 1 has a first female receptacle 10 connected on an end thereof opposite to the main power switch of the home electric circuit, and the first female receptacle 10 is electrically connected with a first end of the first male plug 20 of the first extension cord 2;

the first extension cord 2 including an electromagnetic protection switch 6 connected on a second end of the first extension cord 2, wherein the electromagnetic protection switch 6 has an electricity meter 5 connected on a current output end thereof, the current output end of the electromagnetic protection switch 6 is connected with a second female receptacle 10 via a second extension cord 7, and a specification of the second female receptacle 10 is identical to a specification of the first female receptacle 10, wherein the second female receptacle 10 is configured to connect with the charging gun 8 of the respective electric vehicle, the charging gun 8 includes a second male plug 20 connected on a first end thereof, and a specification of the second male plug 20 is identical to a specification of the first male plug 20, wherein the second male plug 20 is connected with the second female receptacle 10 of the second extension cord 7, the charging gun 8 further includes a third female receptacle 10 connected on a second end thereof, and a specification of the third female receptacle 10 is identical to the specifications of the first and second female receptacles 10;

wherein a respective one of the first, second, third female receptacles 10 includes a substrate 11, a circular ground-wire socket 14 formed on a front end of the substrate 11 of the respective one female receptacle 10, and a circular live-wire socket 15 and a circular neutral wire 16 which are formed adjacent to the circular ground-wire socket 14, wherein a first width a1 and a first height a3 are formed between the circular ground-wire socket 14 and the circular live-wire socket 15, a second width a2 and a second height a4 are formed between the circular ground-wire socket 14 and the circular neutral-wire socket 16, the first width a1 is not equal to the second width a2, and the first height a3 is not equal to the second height 4a; and

wherein a respective one of the first, second, third male plugs 20 includes a base 21, a columnar ground pin 24 formed on a front end of the base 21, a circular live-wire pin 25 and a circular neutral pin 26 which are both formed adjacent to the columnar ground pin 24, wherein the columnar ground pin 24 corresponds to the circular ground-wire socket 14 of the respective one female receptacle 10, the circular live-wire pin 25 corresponds to the circular live-wire socket 15 of the respective one female receptacle 10, and the circular neutral pin 26 corresponds to the circular neutral-wire socket 16 of the respective one female receptacle 10.

The body of the charger extension cable further includes a protective case 3 configured to accommodate the electromagnetic protection switch 6 and the electricity meter 5, and the protective case 3 has a receiving cavity 4 configured to receive the first extension cord 2 and the second extension cord 7;

wherein the substrate 11 of the respective one female receptacle 10 has a female insulation sleeve 12 and a guide segment 13 extending from the female insulation sleeve 12; the circular ground-wire socket 14 of the respective one female receptacle 10 has a ground-wire accommodation sheath 141 extending from an end thereof, and the ground-wire accommodation sheath 141 has a first ground wire 142 extending from an end of the ground-wire accommodation sheath 141 opposite to the circular ground-wire socket 14; wherein the circular live-wire socket 15 of the respective one female receptacle 10 has a live-wire accommodation sheath 151 extending from an end thereof, and the live-wire accommodation sheath 151 has a first live wire 152 extending from an end thereof opposite to the circular live-wire socket 15, wherein the circular neutral-wire socket 16 of the respective one female receptacle 10 has a neutral-wire accommodation sheath 161 formed on an end thereof, and the neutral-wire accommodation sheath 161 has a first neutral wire 162 extending from an end thereof opposite to the circular neutral-wire socket 16;

wherein the base 21 of the respective one male plug 20 has a male insulation sleeve 22 and a receiving groove 23 defined in the male insulation sleeve 22 and configured to accommodate the guide segment 13 of the respective female receptacle 10; the columnar ground pin 24 of the respective one male plug 20 has a ground-wire holder 241 extending from an end thereof, and the ground-wire holder 241 has a second ground wire 142 extending from an end of the ground-wire holder 241 opposite to the columnar ground pin 24; wherein the circular live-wire pin 25 of the respective one male plug 20 has a live-wire holder 251 extending from an end thereof, and the live-wire holder 251 has a second live wire 252 extending from an end thereof opposite to the circular-live wire pin 25, wherein the circular neutral pin 26 of the respective one male plug 20 has a neutral-wire holder 261 formed on an end thereof, and the neutral-wire holder 261 has a second neutral wire 262 extending from an end thereof opposite to the circular neutral pin 26;

wherein a diameter of the columnar ground pin 24 of the respective one male plug 20 is less than a diameter of the circular live-wire pin 25 and a diameter of the circular neutral pin 26; a diameter of the circular ground-wire socket 14 of the respective one female receptacle 10 is less than a diameter of the circular live-wire socket 15 and the circular neutral-wire socket 16.

Thereby, cross sections of the columnar ground pin 24, the circular-live wire pin 25, and the circular neutral pin 26 of the respective one male plug 20 and cross sections of the circular ground-wire socket 14, the circular live-wire socket 15 and the circular neutral-wire socket 16 of the respective one female receptacle 10 are circular so that the respective one male plug 20 electrically contacts with the respective one female receptacle 10 completely, thus enhancing charging efficiency. Preferably, the respective one male plug 20 and the respective one female receptacle 10 are connected with the home electric circuit electrically to enhance a charging convenience. The columnar ground pin 24, the circular-live wire pin 25, and the circular neutral pin 26 of the respective one male plug 20 are arranged asymmetrical to the circular ground-wire socket 14, the circular live-wire socket 15 and the circular neutral-wire socket 16 of the respective one female receptacle 10 to obtain foolproof protection of the respective one male plug 20 and the respective one female receptacle 10, using unity and safety of the electric vehicles, and share specification of the electric vehicles in a world.

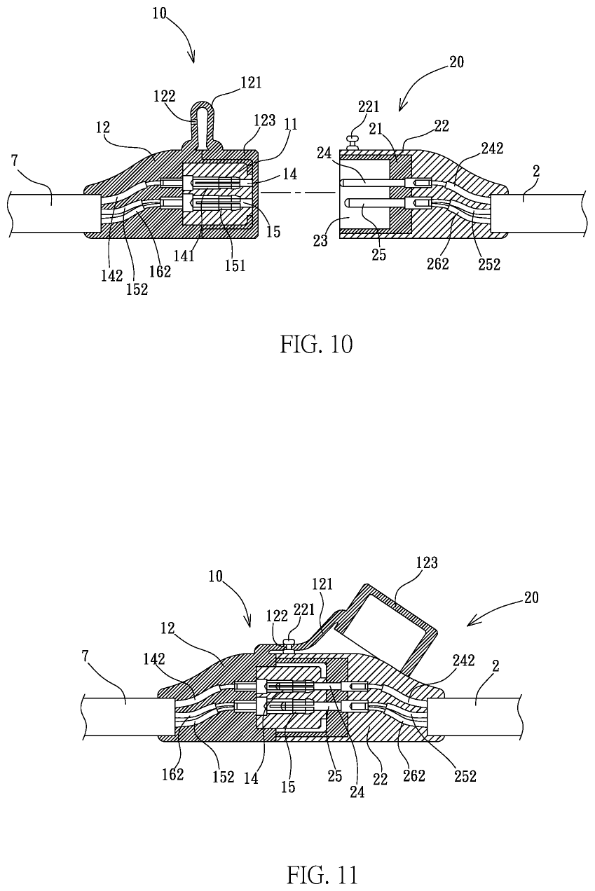

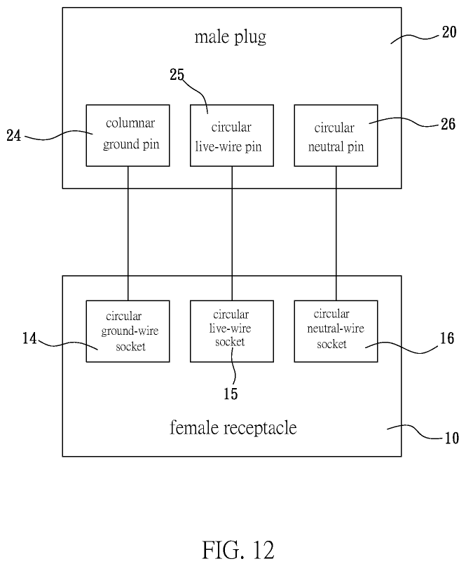

Referring to FIGS. 10-11, a difference of a male plug and a female receptacle of a charger extension cable of a second embodiment from that of the first embodiment comprises: a female insulation sleeve 12 of a first female receptacle 10 having a connection section 121 one-piece formed on a top of the female insulation sleeve 12, a guard cap 123 formed on an end of the connection section 121, wherein the guard cap 123 is covered on the guide segment 13 to prevent an object being inserted into the first female receptacle 10, when the first female receptacle 10 is not electrically connected. The connection section 121 has a locking aperture 122 defined on a predetermined position thereof, and the male insulation sleeve 22 of the respective one male plug 20 has a post extending from a predetermined position of a top thereof, such that the locking aperture 122 is engaged with the post 221, when the first female receptacle 10 is electrically connected with the respective one plug 20, thus connecting the respective one male plug 20 with the first female receptacle 10 securely. FIG. 12 is a block diagram showing the structure of the male plug and the female receptacle of the charger extension cable according to the present invention.

The male plug and the female receptacle of the charger extension cable of the second embodiment comprise a body which includes a first extension cord 2, a distal end of which is connected with the first female receptacle 10, and the first female receptacle 10 is electrically connected with a home electric circuit, wherein the home electric circuit has an incoming terminal 1 electrically connected thereon and with an current output end of a main power switch of the home electric circuit in a power outgoing direction, and the incoming terminal 1 has a male plug 20 connected on an end thereof opposite to the main power switch of the home electric circuit, wherein the male plug 20 is electrically connected with a first end of the female receptacle 10 of the first extension cord 2;

wherein the first extension cord 2 includes an electromagnetic protection switch 6 connected on a second end thereof, the electromagnetic protection switch 6 has an electricity meter 5 connected on a current output end thereof, and the current output end of the electromagnetic protection switch 6 is connected with a second male plug 20 via a second extension cord 7, wherein a specification of the second male plug 20 is identical to a specification of the first male plug 20, and the second female receptacle 10 is configured to connect with the charging gun 8 of the respective electric vehicle, wherein the charging gun 8 includes a second female receptacle 10 connected on a first end thereof, and a specification of the second female receptacle 10 is identical to a specification of the first female receptacle 10, wherein the second female receptacle 10 is connected with the second male receptacle 20 of the second extension cord 7, and the charging gun 8 further includes a third male plug 20 connected on a second end thereof, wherein a specification of the third male plug 20 is identical to the specifications of the first and second male plugs 20.

Thereby, the respective one male plug 20 and the respective one female receptacle 10 are connected with the home electric circuit electrically to enhance a charging convenience

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A male plug and a female receptacle of a charger extension cable for electric vehicles being configured to be connected between a home electric circuit and a charging gun of a respective one electric vehicle, and the male plug and the female receptacle of the charger extension cable comprising:
a body of the charger extension cable including a first extension cord, a distal end of which is connected with a first male plug, and the first male plug being electrically connected with the home electric circuit, wherein the home electric circuit has an incoming terminal electrically connected thereon and with a current output end of a main power switch of the home electric circuit in a power outgoing direction, the incoming terminal has a first female receptacle connected on an end thereof opposite to the main power switch of the home electric circuit, and the first female receptacle is electrically connected with a first end of the first male plug of the first extension cord;
the first extension cord including an electromagnetic protection switch connected on a second end of the first extension cord, wherein the electromagnetic protection switch has an electricity meter connected on a current output end thereof, the current output end of the electromagnetic protection switch is connected with a second female receptacle via a second extension cord, and a specification of the second female receptacle is identical to a specification of the first female receptacle, wherein the second female receptacle is configured to connect with the charging gun of the respective electric vehicle, the charging gun includes a second male plug connected on a first end thereof, and a specification of the second male plug is identical to a specification of the first male plug, wherein the second male plug is connected with the second female receptacle of the second extension cord, the charging gun further includes a third female receptacle connected on a second end thereof, and a specification of the third female receptacle is identical to the specifications of the first and second female receptacles;
wherein a respective one of the first, second, third female receptacles includes a substrate, a circular ground-wire socket formed on a front end of the substrate of the respective one female receptacle, a circular live-wire socket and a circular neutral wire which are formed adjacent to the circular ground-wire socket, and a first width and a first height are formed between the circular ground-wire socket and the circular live-wire socket, wherein a second width and a second height are formed between the circular ground-wire socket and the circular neutral-wire socket, the first width is not equal to the second width, and the first height is not equal to the second height; and
wherein a respective one of the first, second, third male plugs includes a base, a columnar ground pin formed on a front end of the base, a circular live-wire pin and a circular neutral pin which are both formed adjacent to the columnar ground pin, and the columnar ground pin corresponds to the circular ground-wire socket of the respective one female receptacle, the circular live-wire pin corresponds to the circular live-wire socket of the respective one female receptacle, and the circular neutral pin corresponds to the circular neutral-wire socket of the respective one female receptacle.

2. The male plug and the female receptacle of the charger extension cable as claimed in claim 1, wherein the body of the charger extension cable further includes a protective case configured to accommodate the electromagnetic protection switch and the electricity meter, and the protective case has a receiving cavity configured to receive the first extension cord and the second extension cord.

3. The male plug and the female receptacle of the charger extension cable as claimed in claim 1, wherein the substrate of the respective one female receptacle has a female insulation sleeve and a guide segment extending from the female insulation sleeve; the circular ground-wire socket of the respective one female receptacle has a ground-wire accommodation sheath extending from an end thereof, and the ground-wire accommodation sheath has a first ground wire extending from an end of the ground-wire accommodation sheath opposite to the circular ground-wire socket; wherein the circular live-wire socket of the respective one female receptacle has a live-wire accommodation sheath extending from an end thereof, and the live-wire accommodation sheath has a first live wire extending from an end thereof opposite to the circular live-wire socket, wherein the circular neutral-wire socket of the respective one female receptacle has a neutral-wire accommodation sheath formed on an end thereof, and the neutral-wire accommodation sheath has a first neutral wire extending from an end thereof opposite to the circular neutral-wire socket.

4. The male plug and the female receptacle of the charger extension cable as claimed in claim 1, wherein the base of the respective one male plug has a male insulation sleeve and a receiving groove defined in the male insulation sleeve and configured to accommodate the guide segment of the respective female receptacle; the columnar ground pin of the respective one male plug has a ground-wire holder extending from an end thereof, and the ground-wire holder has a second ground wire extending from an end of the ground-wire holder opposite to the columnar ground pin; wherein the circular live-wire pin of the respective one male plug has a live-wire holder extending from an end thereof, and the live-wire holder has a second live wire extending from an end thereof opposite to the circular-live wire pin, wherein the circular neutral pin of the respective one male plug has a neutral-wire holder formed on an end thereof, and the neutral-wire holder has a second neutral wire extending from an end thereof opposite to the circular neutral pin.

5. The male plug and the female receptacle of the charger extension cable as claimed in claim 3, wherein the base of the respective one male plug has a male insulation sleeve and a receiving groove defined in the male insulation sleeve and configured to accommodate the guide segment of the respective female receptacle; the columnar ground pin of the respective one male plug has a ground-wire holder extending from an end thereof, and the ground-wire holder has a second ground wire extending from an end of the ground-wire holder opposite to the columnar ground pin; wherein the circular live-wire pin of the respective one male plug has a live-wire holder extending from an end thereof, and the live-wire holder has a second live wire extending from an end thereof opposite to the circular-live wire pin, wherein the circular neutral pin of the respective one male plug has a neutral-wire holder formed on an end thereof, and the neutral-wire holder has a second neutral wire extending from an end thereof opposite to the circular neutral pin.

6. The male plug and the female receptacle of the charger extension cable as claimed in claim 1, wherein a diameter of the columnar ground pin of the respective one male plug is less than a diameter of the circular live-wire pin and a diameter of the circular neutral pin; a diameter of the circular ground-wire socket of the respective one female receptacle is less than a diameter of the circular live-wire socket and the circular neutral-wire socket.
